(19) United States
(12) Patent Application Publication
(10) Pub. No.: US 2025/0202581 A1
(43) Pub. Date: Jun. 19, 2025

(54) RESONANCE STRUCTURE CONTROL LASER DEVICE THROUGH MULTI-CHROMATIC DISPERSION COMPENSATION

(71) Applicant: PUSAN NATIONAL UNIVERSITY INDUSTRY-UNIVERSITY COOPERATION FOUNDATION, Busan (KR)

(72) Inventors: Changseok KIM, Busan (KR); Seongjin BAK, Busan (KR); Gyeonghun KIM, Busan (KR); Hwidon LEE, Busan (KR)

(73) Assignee: PUSAN NATIONAL UNIVERSITY INDUSTRY-UNIVERSITY COOPERATION FOUNDATION, Busan (KR)

(21) Appl. No.: 18/976,368

(22) Filed: Dec. 11, 2024

(30) Foreign Application Priority Data
Dec. 15, 2023 (KR) 10-2023-0182634

(51) Int. Cl. H04B 10/2513; H04B 10/50

(52) U.S. Cl. CPC H04B 10/2513; H04B 10/503

(57) ABSTRACT

A resonance structure control laser device through multi-chromatic dispersion compensation, includes: a laser resonator comprising optical fibers for light circulation; an optical gain modulator generating broadband modulated light in the laser resonator; a symmetric dispersion inducer repeating compression and stretching the light from the optical gain modulator; first and second optical circulators connecting the symmetric dispersion inducer to the laser resonator; and a multi-dispersion compensator positioned inside the laser resonator that compensates for a magnitude, a slope, and a curvature of chromatic dispersion generated in the laser resonator in multiple stages, to ensure symmetrical compression and stretching across the full wavelength range.

### CROSS-REFERENCE TO RELATED APPLICATION

This application claims the benefit of Korean Patent Application No. 10-2023-0182634 filed on Dec. 15, 2023, in the Korean Intellectual Property Office, the entire disclosure of which is incorporated herein by reference for all purposes.

### ACKNOWLEDGEMENT

This work was supported by the National Research Foundation of Korea (NRF) grant funded by the Korea government (MSIT) (No. NRF-2021R1A5A1032937).

This work was supported by Korea Evaluation Institute of Industrial Technology (KEIT) grant funded by the Korea government (MOTIE) (No. 1415181752).

### BACKGROUND

The present disclosure relates to a laser device, and specifically to a resonance structure control laser device through multi-chromatic dispersion compensation that compensates for residual chromatic dispersion, which is nonlinearly present, by its magnitude, slope, and curvature in multiple stages, thereby enabling creation of a narrower pulse width and a longer coherence length compared to conventional lasers that repeat compression and stretching.

In the case of lasers that repeat compression and stretching according to a related art, optical pulses were generated without multiple compensation for wavelength-dependent chromatic dispersion occurring inside the resonator.

As a result, residual chromatic dispersion remained inside the resonator, and compression and stretching did not appear symmetrically depending on a wavelength, so during the process of repeating compression and stretching, it was not possible to make the optical pulse width below a predetermined level, and there was also a problem of the coherence length being relatively reduced.

FIG. 1 is a diagram to illustrate the problem of residual chromatic dispersion in a laser device according to a related art.

All optical fiber resonators have (residual) chromatic dispersion depending on the wavelength.

In the case of lasers that repeat compression and stretching according to the related art, since the chromatic dispersion is not compensated in multiple stages, the pulse width inevitably becomes wider, which leads to a problem of the laser coherence length being reduced.

FIG. 2 is a diagram to illustrate the problem of suppressing first resonance through on/off in a laser device according to a related art.

When on/off control is not applied, both first resonance and second resonance are lasing, and when on/off control is applied, first resonance can be suppressed, and second resonance can be lased.

However, there is a limitation in that the duty cycle can only be generated below 50%.

As such, in a laser setup according to a related art, on/off control of an optical gain modulator was necessary to suppress unnecessary internal first resonance, which led to the problem of the duty ratio being limited to 50% or less.

FIG. 3 is a diagram to illustrate the problem of high-frequency interference signal generation in a laser device according to a related art.

When the stretched output port is used in an interference-based measurement system, interference signals with very high frequencies (˜GHz order) are generated due to the high swept rate (˜MHz order) and the wide wavelength variable range (˜100 nm). When the frequency exceeds the measurable f_{beat} (sampling frequency/2) of the digitizer, accurate interference signal measurement becomes impossible.

In particular, when the laser is operated at high speed to perform optical interference measurements over a predetermined distance, the frequency of the interference signal exceeds the measurement bandwidth of the measurement digitizer, making it impossible to measure accurate interference signals.

Therefore, there is a need for the development of a new technology that can solve the problems of the relatively wide pulse width and low coherence length in the laser setup according to the related art, and solve the problems of the duty ratio being limited to 50% or less.

### PRIOR-ART DOCUMENTS

### Patent Documents

(Patent Document 1) Korean Patent Application Publication No. 10-1998-0050574
(Patent Document 2) Korean Patent Application Publication No. 10-2014-0052116
(Patent Document 3) Korean Patent Application Publication No. 10-2016-0109809

### SUMMARY

An aspect of the present disclosure is to solve the problems of laser devices according to the related art and to provide a resonance structure control laser device through multi-chromatic dispersion compensation that compensates for residual chromatic dispersion, which is nonlinearly present, in multiple stages, thereby enabling the creation of a narrower pulse width and higher coherence length compared to lasers that repeat conventional compression and stretching.

An aspect of the present disclosure is to provide a resonance structure control laser device through multi-chromatic dispersion compensation that enables accurate interference signal measurement by having a resonance structure in which wavelength-dependent compression and stretching of optical pulses are symmetrically repeated through multi-chromatic dispersion compensation.

An aspect of the present disclosure is to provide a resonance structure control laser device through multi-chromatic dispersion compensation to solve the problem of the duty ratio being limited to 50% or less, which occurs due to the need for an on/off control of the optical gain modulator to suppress unnecessary internal resonance in the laser setup.

Other objects of the present disclosure are not limited to the aforementioned objects, and additional objects not mentioned can be clearly understood by those skilled in the art from the following description.

A resonance structure control laser device through multi-chromatic dispersion compensation according to the present disclosure to achieve the aforementioned objects includes: a laser resonator comprising optical fibers for light circulation; an optical gain modulator generating broadband modulated light with the laser resonator; a symmetric dispersion inducer repeating compression and stretching the modulated light from the optical gain modulator; first and second optical circulators connecting the symmetric dispersion inducer to the laser resonator; and a multi-dispersion compensator positioned inside the laser resonator that compensates for a magnitude, a slope, and a curvature of chromatic dispersion generated in the laser resonator in multiple stages, to ensure symmetrical compression and stretching across the full wavelength range.

Here, the first optical circulator may receive light from the optical gain modulator at a first port and send it to the symmetric dispersion inducer connected to a second port, and receive stretched light from the symmetric dispersion inducer at the second port and output it to a third port, and the second optical circulator may receive light from the third port within the first optical circulator at a first port and send it to the symmetric dispersion inducer connected to a second port, and receive compressed light in the symmetric dispersion inducer at the second port and output it to a third port.

Further, the symmetric dispersion inducer may be connected to the first optical circulator to induce the stretching of light and be connected to the second optical circulator to induce the compression of light.

Further, the resonance structure control laser device may further include one or more of either a first optical coupler, positioned in the laser resonator and outputting the compressed light to the outside, or a second optical coupler, positioned in the laser resonator and outputting the stretched light to the outside.

Further, the optical gain modulator may include a first optical gain modulator generating broadband light positioned between a third port of the first optical circulator and a first port of the second optical circulator, and a second optical gain modulator generating broadband light as pulsed light positioned between a third port of the second optical circulator and a first port of the first optical circulator.

Further, the optical gain modulator generating the broadband light may be positioned between a third port of the first optical circulator and a first port of the second optical circulator, and an optical modulator generating broadband light as pulsed light is positioned between a third port of the second optical circulator and a first port of the first optical circulator.

Further, the resonance structure control laser device may further include an additional dispersion inducer further stretching the light outputted outside the laser resonator.

Further, the resonance structure control laser device may include a discontinuous symmetric dispersion inducer in the form of a reflector that exists discontinuously with respect to a wavelength instead of the symmetric dispersion inducer, and a stretched light output spectrum may exhibit discontinuous characteristics according to the wavelength.

A resonance structure control laser device through multi-chromatic dispersion compensation according to the present disclosure to achieve another object includes: a laser resonator having a resonance structure in which wavelength-dependent compression and stretching of optical pulses are symmetrically repeated; an optical gain modulator oscillating broadband light with the laser resonator; a symmetric dispersion inducer repeating compression and stretching on the light oscillated by the optical gain modulator; a multi-dispersion compensator compensating for a magnitude, a slope, and a curvature of wavelength-dependent chromatic dispersion generated in the broadband in multiple stages and inducing compression and stretching to occur symmetrically across an entire band; first, second, and third optical circulators connecting the symmetric dispersion inducer and the multi-dispersion compensator to the laser resonator; and an optical coupler making an output port by dividing light amplified from the laser resonator at a constant ratio.

Here, the optical coupler may include one or more of either a first optical coupler, positioned in the laser resonator and outputting the compressed light to the outside, or a second optical coupler, positioned in the laser resonator and outputting the stretched light to the outside.

Further, the resonance structure control laser device may further include an optical modulator generating the broadband light as pulsed light.

Further, the resonance structure control laser device may further include an additional dispersion inducer further stretching the light exiting through the output port.

A resonance structure control laser device through multi-chromatic dispersion compensation according to the present disclosure to achieve yet another object includes: a laser resonator having a resonance structure in which wavelength-dependent compression and stretching of optical pulses are symmetrically repeated; an optical gain modulator oscillating broadband light with the laser resonator; a symmetric dispersion inducer repeating compression and stretching the light oscillated by the optical gain modulator; first and second multi-dispersion compensators compensating for a magnitude, a slope, and a curvature of wavelength-dependent chromatic dispersion generated in the broadband in the laser resonator in multiple stages, inducing compression and stretching to occur symmetrically across an entire band, and using transmitted light as an output port; first and second optical circulators connecting the symmetric dispersion inducer to the laser resonator; and third and fourth optical circulators connecting the first and second multi-dispersion compensators to the laser resonator.

Here, the resonance structure control laser device may further include an optical modulator generating the broadband light as pulsed light.

Further, the resonance structure control laser device may further include an additional dispersion inducer further stretching the light exiting through the output port.

A resonance structure control laser device through multi-chromatic dispersion compensation according to the present disclosure to achieve yet another object includes: a laser resonator having a resonance structure in which wavelength-dependent compression and stretching of optical pulses are symmetrically repeated; an optical gain modulator oscillating broadband light with the laser resonator; a discontinuous symmetric dispersion inducer discontinuously repeating compression and stretching of the light oscillated by the optical gain modulator according to a wavelength; a multi-dispersion compensator compensating for a magnitude, a slope, and a curvature of wavelength-dependent chromatic dispersion generated in the broadband in the laser resonator in multiple stages and inducing compression and stretching to occur symmetrically across an entire band; first, second, and third optical circulators connecting the discontinuous symmetric dispersion inducer and the multi-dispersion compensator to the laser resonator; and an optical coupler making an output port by dividing the light amplified from the laser resonator at a constant ratio.

Here, the optical coupler may include one or more of either a first optical coupler, positioned in the laser resonator and outputting the compressed light to the outside, or a second optical coupler, positioned in the laser resonator and outputting the stretched light to the outside.

A resonance structure control laser device through multi-chromatic dispersion compensation according to the present disclosure to achieve yet another object includes: a laser resonator having a resonance structure in which wavelength-dependent compression and stretching of optical pulses are symmetrically repeated; an optical gain modulator oscillating broadband light with the laser resonator; a discontinuous symmetric dispersion inducer repeating compression and stretching of the light oscillated by the optical gain modulator discontinuously according to a wavelength; first and second multi-dispersion compensators compensating for a magnitude, a slope, and a curvature of wavelength-dependent chromatic dispersion generated in the broadband in the laser resonator in multiple stages, inducing compression and stretching to occur symmetrically across an entire band, and using transmitted light as an output port; first and second optical circulators connecting the discontinuous symmetric dispersion inducer to the laser resonator; and third and fourth optical circulators connecting the first and second multi-dispersion compensators to the laser resonator.

A resonance structure control laser device through multi-chromatic dispersion compensation according to the present disclosure, as described above, has the following effects.

First, it may allow for the creation of a narrow pulse width and a high coherence length by compensating for the residual chromatic dispersion, which is nonlinearly present, in multiple stages.

Second, it may enable accurate interference signal measurement by having a resonance structure in which wavelength-dependent compression and stretching of optical pulses are symmetrically repeated through multi-chromatic dispersion compensation.

Third, it may solve the problem of the duty ratio being limited to 50% or less, which occurs due to the need for on/off control of the optical gain modulator to suppress unnecessary internal resonance in the laser setup.

### BRIEF DESCRIPTION OF THE DRAWINGS

FIG. 1 is a diagram to illustrate the problem of residual chromatic dispersion in a laser device according to a related art.

FIG. 2 is a diagram to illustrate the problem of suppressing first resonance through on/off in a laser device according to a related art.

FIG. 3 is a diagram to illustrate the problem of high-frequency interference signal generation in a laser device according to a related art.

FIG. 4 is a diagram to illustrate a configuration and operational characteristics of the resonance structure control laser device through multi-chromatic dispersion compensation according to the present disclosure.

FIG. 5 is a diagram to illustrate the configuration of the resonance structure control laser device through multi-chromatic dispersion compensation according to the first embodiment of the present disclosure.

FIG. 6 is a diagram to illustrate the configuration of the resonance structure control laser device through multi-chromatic dispersion compensation according to the second embodiment of the present disclosure.

FIGS. 7A and 7B are diagrams to illustrate the configuration of the resonance structure control laser device through multi-chromatic dispersion compensation according to the third embodiment of the present disclosure.

FIG. 8 is a diagram to illustrate the configuration of the resonance structure control laser device through multi-chromatic dispersion compensation according to the fourth embodiment of the present disclosure.

FIG. 9 is a diagram to illustrate the configuration of the resonance structure control laser device through multi-chromatic dispersion compensation according to the fifth embodiment of the present disclosure.

FIG. 10 is a diagram to illustrate the configuration of the resonance structure control laser device through multi-chromatic dispersion compensation according to the sixth embodiment of the present disclosure.

FIGS. 11 to 14 are diagrams to illustrate the operational characteristics of the resonance structure control laser device through multi-chromatic dispersion compensation according to the present disclosure.

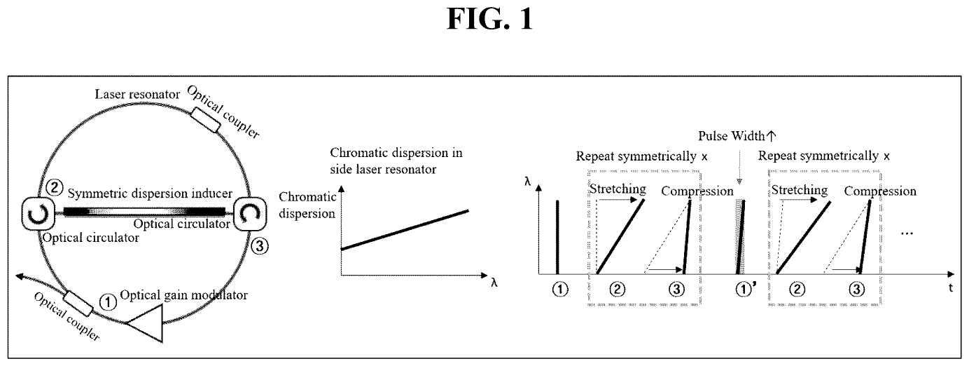

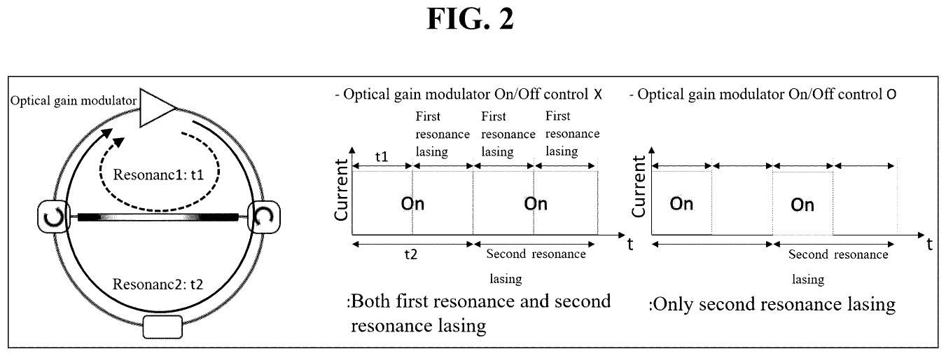

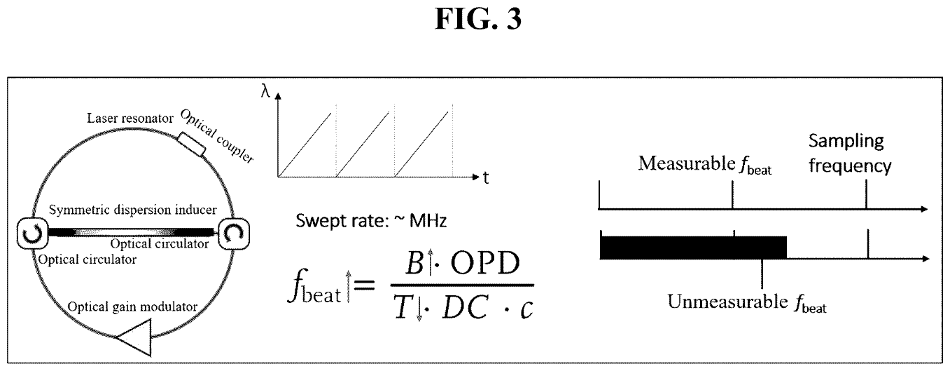

### DETAILED DESCRIPTION

Hereinafter, preferred embodiments of a resonance structure control laser device through multi-chromatic dispersion compensation according to the present disclosure will be described in detail as follows.

The features and advantages of the resonance structure control laser device through multi-chromatic dispersion compensation according to the present disclosure will become apparent through the detailed descriptions of the following embodiments.

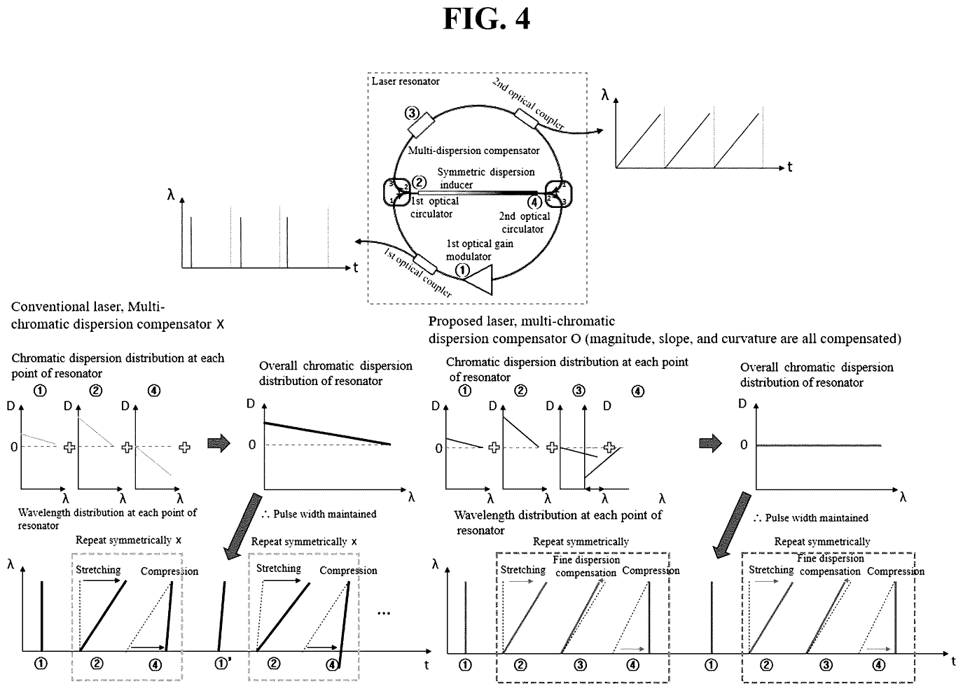

FIG. 4 is a diagram to illustrate the configuration and operational characteristics of the resonance structure control laser device through multi-chromatic dispersion compensation according to the present disclosure.

The terminology used in the present disclosure has been selected as general terms that are as widely used as possible at present, considering the functions of the present disclosure, but these terms may vary depending on the intent of those skilled in the art, legal precedents, or the emergence of new technologies. Additionally, in particular cases, terms arbitrarily selected by the applicant may be used, and in such cases, the meanings of these terms will be described in detail in the relevant portions of the detailed description. Therefore, the terminology used in the present disclosure should not be interpreted based solely on the names of the terms, but should be defined based on the meanings they hold and the overall content of the present disclosure.

Throughout the specification, if a part “comprises” or “includes” a component, it means that it may further include other component rather than excluding other components unless the context indicates otherwise. Additionally, the terms such as “ . . . unit” or “module” described in the specification refer to a unit that performs at least one function or operation, and it may be implemented as hardware, software, or a combination of both.

The resonance structure control laser device through multi-chromatic dispersion compensation according to the present disclosure compensates for residual chromatic dispersion, which is nonlinearly present, by its magnitude, slope, and curvature in multiple stages, thereby enabling the creation of a narrower pulse width and a higher coherence length compared to lasers that repeat conventional compression and stretching.

To achieve this, the present disclosure includes a configuration to solve the problems of relatively wide pulse width and low coherence length in conventional setups by applying multiple corrections to the wavelength-dependent chromatic dispersion, which makes the chromatic dispersion inside a resonator to near zero by adding a multi-dispersion compensator inside a laser resonator, thereby allowing stretching and compression to be symmetrically repeated.

The present disclosure may include a configuration that adds an additional dispersion inducer to the output port, which has a spectrum with a duty cycle of 50% or less, and the additional dispersion inducer creates further wavelength-dependent delay effects, allowing the duty cycle to be made to 100% or less, thereby solving the problem of the duty ratio that was limited to 50% or less in conventional laser setups.

The present disclosure may include a configuration that uses a discontinuous symmetric dispersion inducer to create a discontinuous optical output spectrum, thereby causing an optical subsampling effect and achieving the effect of preventing the optical interference frequency from exceeding a predetermined level.

The basic configuration and operational characteristics of the resonance structure control laser device through multi-chromatic dispersion compensation according to the present disclosure are described in detail as follows.

The resonance structure control laser device through multi-chromatic dispersion compensation according to the present disclosure, as shown in FIG. 4, primarily consists of optical fibers and includes a laser resonator that circulates light, an optical gain modulator that generates broadband light with the laser resonator, a first optical circulator that receives light from the optical gain modulator at a first port and sends it to a symmetric dispersion inducer connected to a second port, and receives the stretched light from the symmetric dispersion inducer at the second port and outputs it to a third port, a second optical circulator that receives the light from the third port within the first optical circulator at a first port and sends it to the symmetric dispersion inducer connected to a second port, and receives the compressed light from the symmetric dispersion inducer at the second port and outputs it to a third port, the symmetric dispersion inducer connected to the first optical circulator to induce the stretching of light and connected to the second optical circulator to induce the compression of light, a multi-dispersion compensator positioned inside the laser resonator that compensates for the magnitude, slope, and curvature of chromatic dispersion generated in the laser resonator in multiple stages to symmetrically generate compression and stretching across the entire wavelength range, and an optical coupler positioned in the laser resonator, which includes one or more of either a first optical coupler that outputs the compressed light to the outside or a second optical coupler that outputs the stretched light to the outside.

Here, a first optical gain modulator that generates broadband light may be positioned between the third port of the first optical circulator and the first port of the second optical circulator, and a second optical gain modulator that generates broadband light as pulsed light may be positioned between the third port of the second optical circulator and the first port of the first optical circulator.

In addition, an optical gain modulator that generates broadband light may be positioned between the third port of the first optical circulator and the first port of the second optical circulator, and an optical modulator that generates broadband light as pulsed light may be positioned between the third port of the second optical circulator and the first port of the first optical circulator.

In addition, it may be a structure further including an additional dispersion inducer that further stretches the light output from the laser resonator to the outside.

In addition, it is possible to have a structure that includes a discontinuous symmetrical dispersion induction in the form of a reflector that exists discontinuously with respect to the wavelength, so that the stretched light output spectrum exhibits discontinuous characteristics according to the wavelength.

By using these characteristics, the wavelength-dependent chromatic dispersion generated inside the laser resonator is compensated in multiple stages to solve the problem of relatively wide pulse width and low coherence length that the conventional setup had.

In other words, as shown in FIG. 4, the multi-dispersion compensator is added inside the laser resonator to make the chromatic dispersion inside the resonator to near zero, allowing symmetric repetition of stretching and compression.

In addition, the additional dispersion inducer is added to the output port, which has a spectrum with a duty cycle of 50% or less, creating further wavelength-dependent delay effects, allowing the duty cycle to be made to 100% or less, thereby solving the problem of the duty ratio that was limited to 50% or less in conventional laser setups.

In addition, an optical subsampling effect is caused by using a discontinuous symmetric dispersion inducer to create a discontinuous optical output spectrum, and as a result, the optical interference frequency can be prevented from exceeding a predetermined level, thereby solving the problem where the frequency of the interference signal exceeds the measurable f_{beat} during high-speed operation.

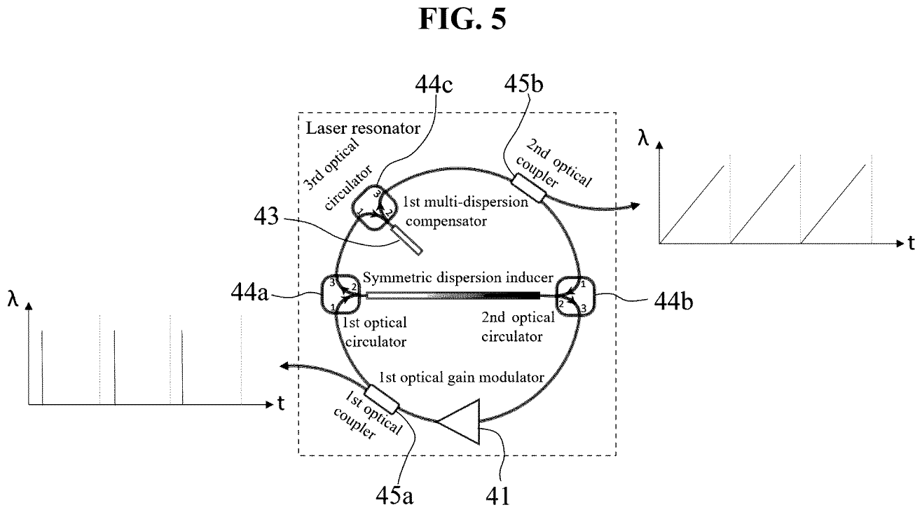

FIG. 5 is a diagram to illustrate the configuration of the resonance structure control laser device through multi-chromatic dispersion compensation according to the first embodiment of the present disclosure.

The resonance structure control laser device through multi-chromatic dispersion compensation according to the first embodiment of the present disclosure, as shown in FIG. 5, includes a laser resonator having a resonance structure in which wavelength-dependent compression and stretching of optical pulses are symmetrically repeated, and includes an optical gain modulator 41 oscillating broadband light with the laser resonator, a symmetric dispersion inducer 42 repeating compression and stretching on the light oscillated by the optical gain modulator 41, a multi-dispersion compensator 43 compensating for the magnitude, slope, and curvature of wavelength-dependent chromatic dispersion generated across the broadband in the laser resonator in multiple stages to induce compression and stretching to occur symmetrically across the entire band, optical circulators 44a, 44b, 44c connecting the symmetric dispersion inducer 42 and the multi-dispersion compensator 43 to the laser resonator, and optical couplers 45a, 45b making an output port by dividing the light amplified in the laser resonator at a constant ratio.

The resonance structure control laser device through multi-chromatic dispersion compensation according to the first embodiment of the present disclosure is a structure including an optical coupler.

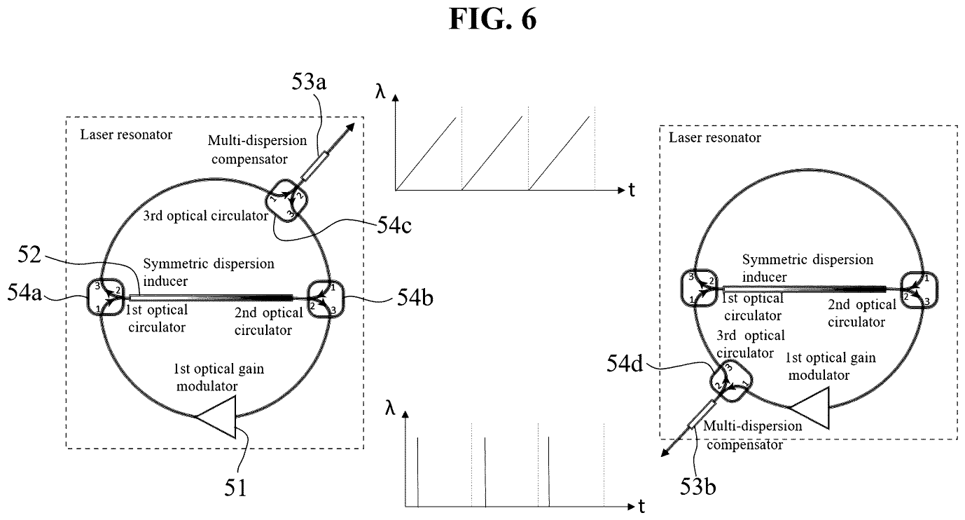

FIG. 6 is a diagram to illustrate the configuration of the resonance structure control laser device through multi-chromatic dispersion compensation according to the second embodiment of the present disclosure.

The resonance structure control laser device through multi-chromatic dispersion compensation according to the second embodiment of the present disclosure, as shown in FIG. 6, includes a laser resonator having a resonance structure in which wavelength-dependent compression and stretching of optical pulses are symmetrically repeated, and includes an optical gain modulator 51 oscillating broadband light with the laser resonator, a symmetric dispersion inducer 52 repeating compression and stretching on the light oscillated by the optical gain modulator 51, multi-dispersion compensators 53a, 53b compensating for the magnitude, slope, and curvature of wavelength-dependent chromatic dispersion generated across the broadband in the laser resonator in multiple stages to induce compression and stretching to occur symmetrically across the entire band and using transmitted light as an output port, and optical circulators 54a, 54b, 54c, 54d connecting the symmetric dispersion inducer 52 and the multi-dispersion compensators 53a, 53b to the laser resonator.

The resonance structure control laser device through multi-chromatic dispersion compensation according to the second embodiment of the present disclosure is a structure not including an optical coupler.

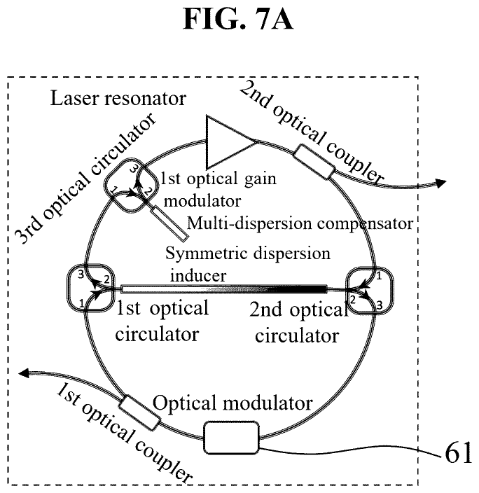

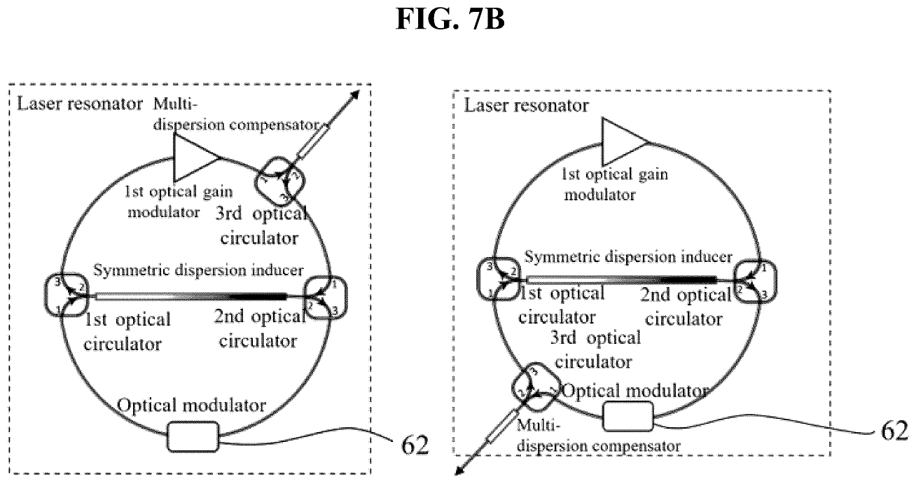

FIGS. 7A and 7B are diagrams to illustrate the configuration of the resonance structure control laser device through multi-chromatic dispersion compensation according to the third embodiment of the present disclosure.

The resonance structure control laser device through multi-chromatic dispersion compensation according to the third embodiment of the present disclosure is a structure including an optical modulator that generates broadband light as pulsed light.

FIG. 7A illustrates a structure further including an optical modulator 61 that generates broadband light as pulsed light in the resonance structure control laser device through multi-chromatic dispersion compensation according to the first embodiment.

FIG. 7B illustrates a structure further including an optical modulator 62 that generates broadband light as pulsed light in the resonance structure control laser device through multi-chromatic dispersion compensation according to the second embodiment.

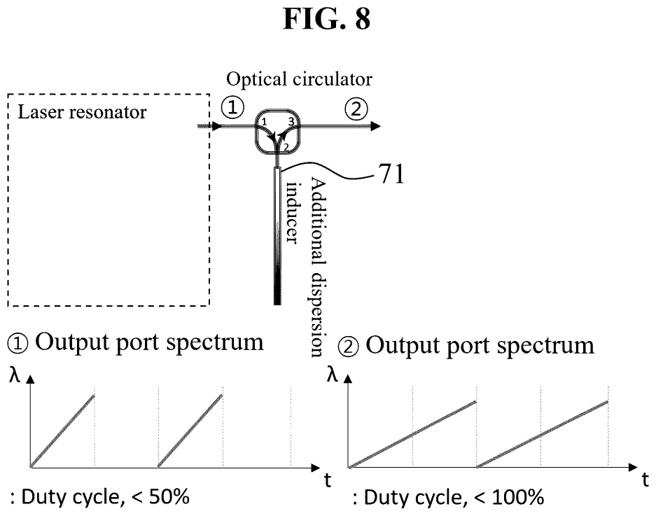

FIG. 8 is a diagram to illustrate the configuration of the resonance structure control laser device through multi-chromatic dispersion compensation according to the fourth embodiment of the present disclosure.

The resonance structure control laser device through multi-chromatic dispersion compensation according to the fourth embodiment of the present disclosure, as shown in FIG. 8, illustrates a structure further including an additional dispersion inducer 71 that further stretches the light exiting through the output port in the resonance structure control laser device through multi-chromatic dispersion compensation according to the first, second, and third embodiments of the present disclosure.

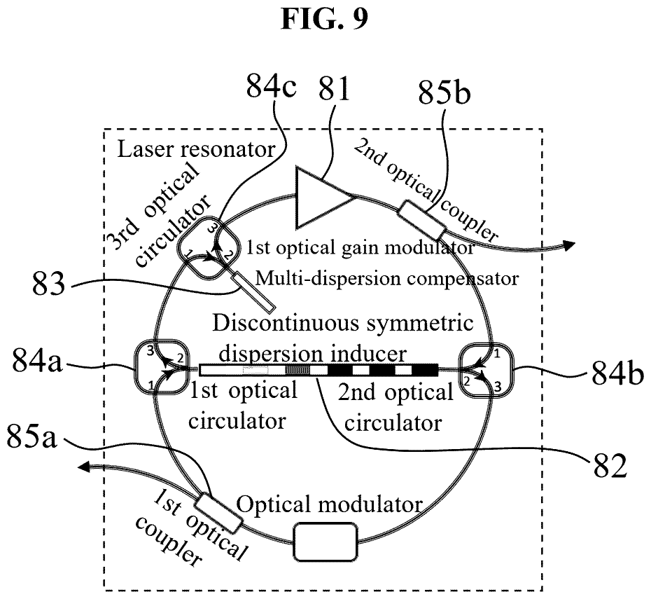

FIG. 9 is a diagram to illustrate the configuration of the resonance structure control laser device through multi-chromatic dispersion compensation according to the fifth embodiment of the present disclosure.

The resonance structure control laser device through multi-chromatic dispersion compensation according to the fifth embodiment of the present disclosure, as shown in FIG. 9, includes a laser resonator having a resonance structure in which wavelength-dependent compression and stretching of optical pulses are symmetrically repeated, and includes an optical gain modulator 81 oscillating broadband light with the laser resonator, a discontinuous symmetric dispersion inducer 82 repeating compression and stretching of the light oscillated by the optical gain modulator 81 discontinuously according to a wavelength, a multi-dispersion compensator 83 compensating for the magnitude, slope, and curvature of wavelength-dependent chromatic dispersion generated across the broadband in the laser resonator in multiple stages, inducing compression and stretching to occur symmetrically across the entire band, optical circulators 84a, 84b, 84c connecting the discontinuous symmetric dispersion inducer 82 and the multi-dispersion compensator 83 to the laser resonator, and optical couplers 85a, 85b to make an output port by dividing the light amplified from the laser resonator at a constant ratio. The resonance structure control laser device is characterized by the structure, having a resonance structure in which wavelength-dependent compression and stretching of optical pulses overcoming the coherence length and measurement distance limitations are symmetrically and discontinuously repeated.

The resonance structure control laser device through multi-chromatic dispersion compensation according to the fifth embodiment of the present disclosure illustrates a structure including a discontinuous symmetric dispersion inducer and an optical coupler.

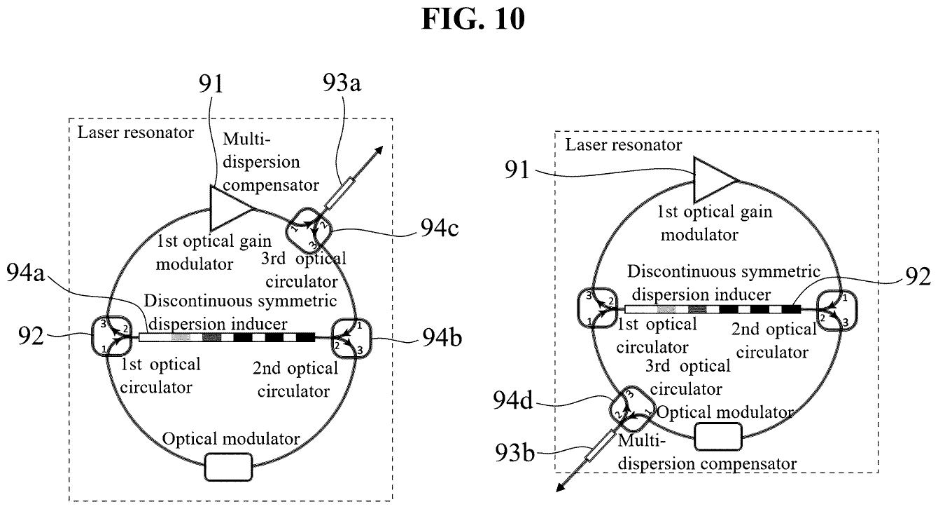

FIG. 10 is a diagram to illustrate the configuration of the resonance structure control laser device through multi-chromatic dispersion compensation according to the sixth embodiment of the present disclosure.

The resonance structure control laser device through multi-chromatic dispersion compensation according to the sixth embodiment of the present disclosure, as shown in FIG. 10, includes a laser resonator having a resonance structure in which wavelength-dependent compression and stretching of optical pulses are symmetrically repeated, and includes an optical gain modulator 91 oscillating broadband light with the laser resonator, a discontinuous symmetric dispersion inducer 92 repeating compression and stretching of the light oscillated by the optical gain modulator 91 discontinuously according to a wavelength, multi-dispersion compensators 93a, 93b compensating for the magnitude, slope, and curvature of wavelength-dependent chromatic dispersion generated across the broadband in the laser resonator in multiple stages, inducing compression and stretching to occur symmetrically across the entire band and using transmitted light as an output port, and optical circulators 94a, 94b, 94c, 94d connecting the discontinuous symmetric dispersion inducer 92 and the multi-dispersion compensators 93a, 93b to the laser resonator. The resonance structure control laser device is characterized by the structure, having a resonance structure in which wavelength-dependent compression and stretching of optical pulses overcoming the coherence length and measurement distance limitations are symmetrically and discontinuously repeated.

The resonance structure control laser device through multi-chromatic dispersion compensation according to the sixth embodiment of the present disclosure illustrates a structure including a discontinuous symmetric dispersion inducer and not including an optical coupler.

The operational characteristics of the resonance structure control laser device through multi-chromatic dispersion compensation according to the present disclosure are described as follows.

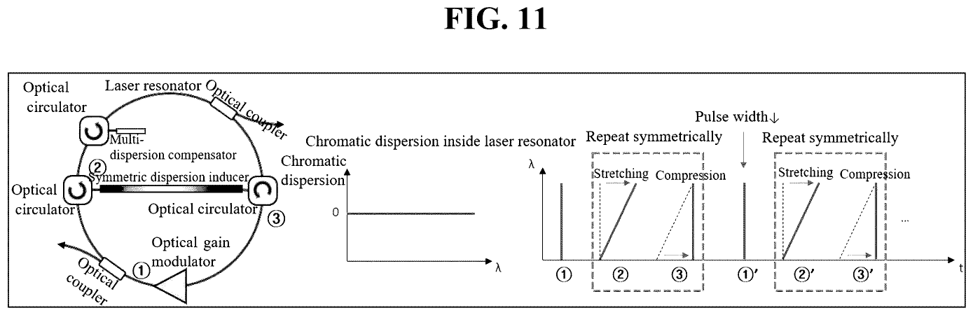

FIGS. 11 to 14 are diagrams to illustrate the operational characteristics of the resonance structure control laser device through multi-chromatic dispersion compensation according to the present disclosure.

FIG. 11 illustrates the characteristics of a structure in which a multi-dispersion compensator is added inside the laser resonator to make the chromatic dispersion inside the resonator to near zero, allowing symmetric repetition of stretching and compression.

By using these characteristics, the wavelength-dependent chromatic dispersion generated inside the laser resonator is compensated in multiple stages to solve the problem of relatively wide pulse width and low coherence length that the conventional setup had.

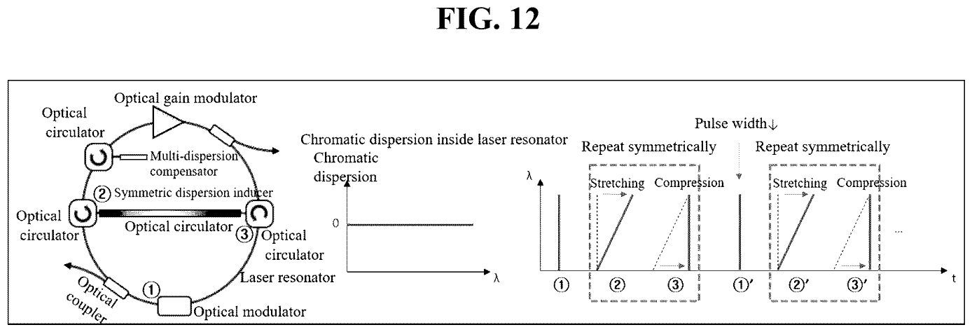

FIG. 12 illustrates the characteristics of a structure in which a multi-dispersion compensator is added inside a laser resonator with an optical modulator to make the chromatic dispersion inside the resonator to near zero, allowing symmetric repetition of stretching and compression.

By using these characteristics, the wavelength-dependent chromatic dispersion generated inside the laser resonator is compensated in multiple stages to solve the problem of relatively wide pulse width and low coherence length that the conventional setup had.

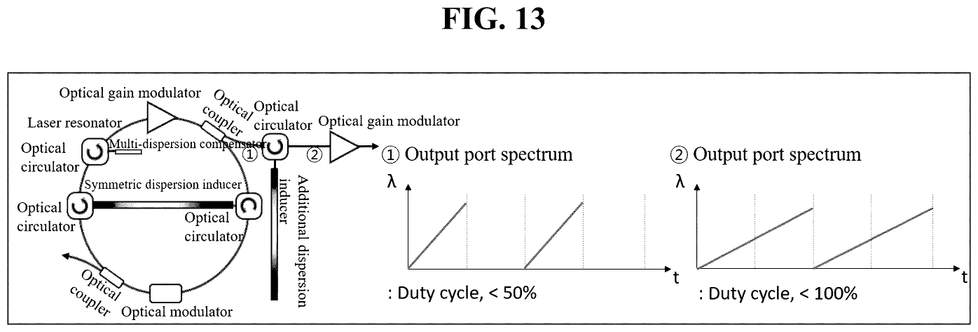

FIG. 13 illustrates a structure in which the additional dispersion inducer is added to the output port, which has a spectrum with a duty cycle of 50% or less, creating further wavelength-dependent delay effects, allowing the duty cycle to be made to 100% or less, thereby solving the problem of the duty ratio that was limited to 50% or less in conventional laser setups.

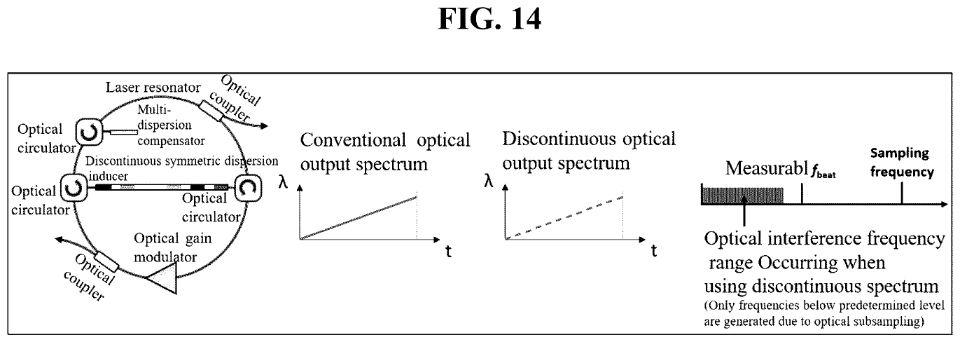

FIG. 14 illustrates the characteristics of a structure that enables the optical output spectrum to be made discontinuous by using a discontinuous symmetric dispersion inducer.

This causes an optical subsampling effect, and as a result, the optical interference frequency can be prevented from exceeding a predetermined level, thereby solving the problem where the frequency of the interference signal exceeds the measurable f_{beat} during high-speed operation.

The resonance structure control laser device through multi-chromatic dispersion compensation according to the present disclosure, as described above, enables precise compensation of the residual chromatic dispersion that is nonlinearly present, allowing for the creation of a narrow pulse width and a high coherence length, and through multi-chromatic dispersion compensation, has a resonance structure in which wavelength-dependent compression and stretching of optical pulses are symmetrically repeated, thereby enabling accurate interference signal measurement.

As described above, it will be understood that the present disclosure may be implemented in modified forms to the extent that it does not deviate from the essential characteristics of the present disclosure.

Therefore, the stated embodiments should be considered from an illustrative point of view rather than a limited one, and the scope of the present disclosure is indicated in the scope of the claims, not the foregoing description, and all differences within the equivalent scope should be interpreted as being included in the present disclosure.

### EXPLANATION OF SYMBOLS

41. Optical gain modulator
42. Symmetric dispersion inducer
43. Multi-dispersion compensator
44a. 44b. 44c. Optical circulators
45a. 45b. Optical couplers

1. A resonance structure control laser device through multi-chromatic dispersion compensation, comprising:
a laser resonator comprising optical fibers for light circulation;
an optical gain modulator generating broadband modulated light with the laser resonator;
a symmetric dispersion inducer repeating compression and stretching the modulated light from the optical gain modulator;
first and second optical circulators connecting the symmetric dispersion inducer to the laser resonator; and
a multi-dispersion compensator positioned inside the laser resonator that compensates for a magnitude, a slope, and a curvature of chromatic dispersion generated in the laser resonator in multiple stages, to ensure symmetrical compression and stretching across the full wavelength range.

2. The resonance structure control laser device through multi-chromatic dispersion compensation according to claim 1, wherein the first optical circulator receives light from the optical gain modulator at a first port and sends it to the symmetric dispersion inducer connected to a second port, and receives the stretched light from the symmetric dispersion inducer at the second port and outputs it to a third port, and
the second optical circulator receives light from the third port within the first optical circulator at a first port and sends it to the symmetric dispersion inducer connected to a second port, and receives the compressed light in the symmetric dispersion inducer at the second port and outputs it to a third port.

3. The resonance structure control laser device through multi-chromatic dispersion compensation according to claim 1, wherein the symmetric dispersion inducer is connected to the first optical circulator to induce the stretching of light and is connected to the second optical circulator to induce the compression of light.

4. The resonance structure control laser device through multi-chromatic dispersion compensation according to claim 1, further comprising one or more of either a first optical coupler, positioned in the laser resonator and outputting the compressed light to the outside, or a second optical coupler, positioned in the laser resonator and outputting the stretched light to the outside.

5. The resonance structure control laser device through multi-chromatic dispersion compensation according to claim 1, wherein the optical gain modulator comprises a first optical gain modulator generating broadband light positioned between a third port of the first optical circulator and a first port of the second optical circulator, and
a second optical gain modulator generating broadband light as pulsed light positioned between a third port of the second optical circulator and a first port of the first optical circulator.

6. The resonance structure control laser device through multi-chromatic dispersion compensation according to claim 1, wherein the optical gain modulator generating the broadband light is positioned between a third port of the first optical circulator and a first port of the second optical circulator, and
an optical modulator generating broadband light as pulsed light is positioned between a third port of the second optical circulator and a first port of the first optical circulator.

7. The resonance structure control laser device through multi-chromatic dispersion compensation according to claim 1, further comprising an additional dispersion inducer further stretching the light outputted outside the laser resonator.

8. The resonance structure control laser device through multi-chromatic dispersion compensation according to claim 1, comprising a discontinuous symmetric dispersion inducer in the form of a reflector that exists discontinuously with respect to a wavelength instead of the symmetric dispersion inducer,
wherein a stretched light output spectrum exhibits discontinuous characteristics according to the wavelength.

9. A resonance structure control laser device through multi-chromatic dispersion compensation, comprising:
a laser resonator having a resonance structure in which wavelength-dependent compression and stretching of optical pulses are symmetrically repeated;
an optical gain modulator oscillating broadband light with the laser resonator;
a symmetric dispersion inducer repeating compression and stretching on the light oscillated by the optical gain modulator;
a multi-dispersion compensator compensating for a magnitude, a slope, and a curvature of wavelength-dependent chromatic dispersion generated in the broadband in multiple stages and inducing compression and stretching to occur symmetrically across an entire band;
first, second, and third optical circulators connecting the symmetric dispersion inducer and the multi-dispersion compensator to the laser resonator; and
an optical coupler making an output port by dividing light amplified from the laser resonator at a constant ratio.

10. The resonance structure control laser device through multi-chromatic dispersion compensation according to claim 9, wherein the optical coupler comprises one or more of either a first optical coupler, positioned in the laser resonator and outputting the compressed light to the outside, or a second optical coupler, positioned in the laser resonator and outputting the stretched light to the outside.

11. The resonance structure control laser device through multi-chromatic dispersion compensation according to claim 9, further comprising an optical modulator generating the broadband light as pulsed light.

12. The resonance structure control laser device through multi-chromatic dispersion compensation according to claim 9, further comprising an additional dispersion inducer further stretching the light exiting through the output port.

13. The resonance structure control laser device through multi-chromatic dispersion compensation according to claim 11, further comprising an additional dispersion inducer further stretching the light exiting through the output port.

14. A resonance structure control laser device through multi-chromatic dispersion compensation, comprising:
a laser resonator having a resonance structure in which wavelength-dependent compression and stretching of optical pulses are symmetrically repeated;
an optical gain modulator oscillating broadband light with the laser resonator;
a symmetric dispersion inducer repeating compression and stretching the light oscillated by the optical gain modulator;
first and second multi-dispersion compensators compensating for a magnitude, a slope, and a curvature of wavelength-dependent chromatic dispersion generated in the broadband in the laser resonator in multiple stages, inducing compression and stretching to occur symmetrically across an entire band, and using transmitted light as an output port;
first and second optical circulators connecting the symmetric dispersion inducer to the laser resonator; and
third and fourth optical circulators connecting the first and second multi-dispersion compensators to the laser resonator.

15. The resonance structure control laser device through multi-chromatic dispersion compensation according to claim 14, further comprising an optical modulator generating the broadband light as pulsed light.

16. The resonance structure control laser device through multi-chromatic dispersion compensation according to claim 14, further comprising an additional dispersion inducer further stretching the light exiting through the output port.

17. The resonance structure control laser device through multi-chromatic dispersion compensation according to claim 15, further comprising an additional dispersion inducer further stretching the light exiting through the output port.

18. A resonance structure control laser device through multi-chromatic dispersion compensation, comprising:
a laser resonator having a resonance structure in which wavelength-dependent compression and stretching of optical pulses are symmetrically repeated;
an optical gain modulator oscillating broadband light with the laser resonator;
a discontinuous symmetric dispersion inducer discontinuously repeating compression and stretching of the light oscillated by the optical gain modulator according to a wavelength;
a multi-dispersion compensator compensating for a magnitude, a slope, and a curvature of wavelength-dependent chromatic dispersion generated in the broadband in the laser resonator in multiple stages and inducing compression and stretching to occur symmetrically across an entire band;
first, second, and third optical circulators connecting the discontinuous symmetric dispersion inducer and the multi-dispersion compensator to the laser resonator; and
an optical coupler making an output port by dividing the light amplified from the laser resonator at a constant ratio.

19. The resonance structure control laser device through multi-chromatic dispersion compensation according to claim 18, wherein the optical coupler comprises one or more of either a first optical coupler, positioned in the laser resonator and outputting the compressed light to the outside, or a second optical coupler, positioned in the laser resonator and outputting the stretched light to the outside.

20. A resonance structure control laser device through multi-chromatic dispersion compensation, comprising:
a laser resonator having a resonance structure in which wavelength-dependent compression and stretching of optical pulses are symmetrically repeated;
an optical gain modulator oscillating broadband light with the laser resonator;
a discontinuous symmetric dispersion inducer discontinuously repeating compression and stretching of the light oscillated by the optical gain modulator according to a wavelength;
first and second multi-dispersion compensators compensating for a magnitude, a slope, and a curvature of wavelength-dependent chromatic dispersion generated in the broadband in the laser resonator in multiple stages, inducing compression and stretching to occur symmetrically across an entire band, and using transmitted light as an output port;
first and second optical circulators connecting the discontinuous symmetric dispersion inducer to the laser resonator; and
third and fourth optical circulators connecting the first and second multi-dispersion compensators to the laser resonator.
